(19) United States
(12) Patent Application Publication
(10) Pub. No.: US 2012/0178016 A1
(43) Pub. Date: Jul. 12, 2012

(54) CATHODE MATERIAL FOR FUEL CELL, CATHODE FOR FUEL CELL INCLUDING THE SAME, METHOD OF MANUFACTURING THE CATHODE, AND SOLID OXIDE FUEL CELL INCLUDING THE CATHODE

(75) Inventors: Hee-jung PARK, Suwon-si (KR); Doh-won JUNG, Seoul (KR)

(73) Assignees: SAMSUNG ELECTRO-MECHANICS CO.., LTD., Suwon-si (KR); SAMSUNG ELECTRONICS CO., LTD., Suwon-si (KR)

(21) Appl. No.: 13/344,866

(22) Filed: Jan. 6, 2012

(30) Foreign Application Priority Data
Jan. 7, 2011 (KR) 10-2011-0001791

(51) Int. Cl. H01M 8/10; B05D 5/12; H01B 1/00

(52) U.S. Cl. 429/482; 252/519.13; 427/115

(57) ABSTRACT

A cathode material for a fuel cell, the cathode material for a fuel cell including a lanthanide metal oxide having a perovskite crystal structure; and a bismuth metal oxide represented by Chemical Formula 1 below,

Bi_{2-x-y}AₓB_{y}O₃, Chemical Formula 1

wherein A and B are each a metal with a valence of 3, A and B are each independently at least one element selected from a rare earth element and a transition metal element, A and B are different from each other, and 0<x≦0.3 and 0<y≦0.3.

### CROSS-REFERENCE TO RELATED APPLICATIONS

This application claims priority to Korean Patent Application No. 10-2011-0001791, filed on Jan. 7, 2011, and all the benefits accruing therefrom under 35 U.S.C. §119, the content of which in its entirety is herein incorporated by reference.

### BACKGROUND

1. Field

The present disclosure relates to a cathode material for a fuel cell, a cathode for a fuel cell including the cathode material, a method of manufacturing the cathode and the cathode material, and a solid oxide fuel cell including the same.

2. Description of the Related Art

A solid oxide fuel cell (“SOFC”) is a high-efficiency, environmentally friendly electrochemical power generation technology in which the chemical energy of a fuel gas is directly transformed into electrical energy. A solid oxide having ionic conductivity is used as an electrolyte. When compared to other fuel cells, the solid oxide fuel cell has many advantages such as relatively low priced materials, relatively high tolerance to fuel impurities, possibility of hybrid power generation, and high efficiency. Also, a hydrocarbon-based fuel may be directly used without reforming the fuel into hydrogen, thus a simple and low-priced fuel cell system is possible. The SOFC is includes an anode where a fuel, such as hydrogen, a hydrocarbon, or the like is oxidized, a cathode where oxygen gas is reduced to oxygen ions (O⁻²), and an ion-conducting solid oxide electrolyte through which the oxygen ions (O⁻²) transport.

A conventional SOFC is operated at a high temperature ranging from about 800° C. to about 1000° C. To accommodate the high operating temperature, conventional SOFCs use expensive high-temperature alloys or ceramic materials, which are able to withstand high temperatures. Also, the high operating temperature results in a long initial system startup time and reduced durability over prolonged periods of operation. A further limitation associated with the high operating temperature is an overall cost increase, which is a significant obstacle to commercialization.

As a result, much research has been conducted in order to decrease the operating temperature of the SOFC to about 800° C. or less. However, reduction of the operating temperature results in a rapid increase in the electrical resistance of an SOFC cathode material, which ultimately becomes a main cause for decreasing power density of the SOFC. Therefore, there remains a need for a cathode material having a decreased electrical resistance for use in a low or medium-temperature SOFC.

### SUMMARY

Provided is a cathode material for a fuel cell capable of decreasing a polarization resistance of a cathode.

Provided is a cathode for a fuel cell including the cathode material for a fuel cell.

Provided is a method of manufacturing the cathode for a fuel cell.

Provided is a solid oxide fuel cell including the cathode.

Additional aspects will be set forth in part in the description which follows and, in part, will be apparent from the description, or may be learned by practice of the presented embodiments.

According to an aspect, a cathode material for a fuel cell includes: a lanthanide metal oxide having a perovskite crystal structure; and a bismuth metal oxide represented by the following Formula 1,

Bi_{2-x-y}AₓByO₃, Formula 1

wherein A and B are each a metal with a valence of 3, A and B are each independently at least one element selected from a rare earth element and a transition metal element, A and B are different from each other, and 0<x≦0.3 and 0<y≦0.3.

The A and B may each be independently selected from Y, La, Pr, Nd, Sm, Eu, Gd, Tb, Dy, Ho, Er, Tm, Yb, and W. For example, when a combination of the A and B is represented by (A, B), the (A, B) may be selected from (Y, Yb), (Dy, Yb), (Gd, Yb), (Tb, Yb), (Y, W), (Dy, W), (Gd, W), (Tb, W), and (Dy, Gd). For example, the (A, B) may be selected from (Y, Yb), (Tb, W), and (Dy, Gd).

The lanthanide metal oxide may include at least one selected from a lanthanum strontium cobalt oxide (“LSC”), a lanthanum strontium cobalt iron oxide (“LSCF”), a lanthanum strontium cobalt manganese oxide (“LSCM”), a lanthanum strontium manganese oxide (“LSM”), and a lanthanum strontium iron oxide (“LSF”).

The bismuth-based metal oxide may be included in the range of about 70 to about 130 parts by weight, based on 100 parts by weight of the lanthanide metal oxide.

According to another aspect, a cathode for a fuel cell includes the cathode material for a fuel cell as disclosed above.

Also disclosed is a method of manufacturing a cathode for a fuel cell, the method including: preparing a solution including the cathode material for a fuel cell as disclosed above; coating the solution on a substrate; and heat treating the coating to manufacture the cathode.

According to another aspect, a solid oxide fuel cell includes: a first cathode including the cathode material for a fuel cell; an anode disposed opposite the first cathode; and a solid oxide electrolyte disposed between the first cathode and the anode.

A functional layer, which substantially prevents or effectively suppresses a reaction between the first cathode and solid oxide electrolyte, may be further included therebetween.

The functional layer may include at least one selected from a gadolinium-doped ceria (“GDC”), a samarium-doped ceria (“SDC”), and a yttrium-doped ceria (“YDC”).

The solid oxide fuel cell may further include a second cathode including an electronic conductor on at least one surface of the first cathode. For example, the second cathode may be disposed at an outer side of the first cathode.

The second cathode may include at least one selected from a lanthanum cobalt oxide (e.g., LaCoO₃), a lanthanum strontium cobalt oxide (“LSC”), a lanthanum strontium cobalt iron oxide (“LSCF”), a lanthanum strontium cobalt manganese oxide (“LSCM”), a lanthanum strontium manganese oxide (“LSM”), and a lanthanum strontium iron oxide (“LSF”).

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual view illustrating a triple phase boundary of a cathode;

FIG. 2 is a cross-sectional view schematically illustrating an embodiment of a structure of a solid oxide fuel cell;

FIG. 3 is a cross-sectional view schematically illustrating another embodiment of a structure of a solid oxide fuel cell;

FIG. 4 is a graph of log conductivity (Siemens/centimeter, S/cm) versus inverse of temperature (1000·inverse Kelvin, 1000K⁻¹) which shows a result of measuring an ionic conductivity of ionic conductors used in cathode materials of Manufacturing Examples 1-2 and ionic conductors of Comparative Examples 1-2;

FIG. 5 is a cross-sectional view illustrating an embodiment of a structure of a unit cell manufactured in Comparative Example 3;

FIG. 6 is a cross-sectional view illustrating an embodiment of a structure of unit cells manufactured in Embodiments 1-4;

FIG. 7 is a graph of reactance (Z₂, ohms) versus resistance (Z₁, ohms) which shows a result of impedance measurements of a unit cell manufactured in Comparative Example 3;

FIG. 8 is a graph of reactance (Z₂, ohms) versus resistance (Z₁, ohms) which shows a result of impedance measurements of a unit cell manufactured in Comparative Example 3 depending on oxygen partial pressures;

FIG. 9 is a graph of resistance (ohms) versus the log of the partial pressure of oxygen (log P_{O2}) which shows a result of resistance measurements of a unit cell manufactured in Comparative Example 3 depending on oxygen partial pressures;

FIG. 10 is a graph of reactance (Z₂, ohms) versus resistance (Z₁, ohms) which shows a result of impedance measurements of unit cells manufactured in Embodiments 1-4;

FIG. 11 is a graph of intensity (arbitrary units) versus scattering angle (degrees two-theta, 2θ) which shows a result of X-ray diffraction pattern measurements on first oxides of unit cells manufactured in Embodiments 1-4; and

FIG. 12 is a graph of the log of resistance (ohms per square centimeter, ohm·cm²) versus the inverse of temperature (1/K) which shows a result of cathode resistance measurements depending on operating temperatures of unit cells manufactured in Comparative Example 3 and Embodiment 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes,” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Rare earth” means at least one of the fifteen lanthanide elements, i.e., atomic numbers 57 to 71, plus scandium and yttrium.

“Lanthanide element” means at least one of the chemical elements with atomic numbers 57 to 71.

“Transition metal” as used herein refers to an element in Groups 3 to 11 of the Periodic Table of the Elements.

In general, an electrochemical reaction of a solid oxide fuel cell, as shown in the following Reaction Equation 1, is composed of a cathode reaction in which oxygen gas (O₂) is changed into oxygen ions (O²⁻) at an air electrode and an anode reaction in which a fuel (e.g., H₂ or hydrocarbon) and the oxygen ion react. The oxygen ion may transport through an electrolyte to the anode, where the reaction occurs.

Cathode: ½O₂+2e⁻→O²⁻

Anode: H₂+O²⁻→H₂O+2e⁻ Reaction Equation 1

A difference in oxygen partial pressure can be maintained by continuously flowing hydrogen to the fuel electrode and air to the air electrode, wherein an electrolyte is disposed therebetween, to provide a driving force to move the oxygen through the electrolyte. If this reaction continuously occurs, then electrons may be conducted from an electrode to an external conducting wire.

In an embodiment, a cathode material for a fuel cell includes a lanthanide metal oxide having a perovskite-type crystal structure and a bismuth-based metal oxide represented by the following Formula 1. While not wanting to be bound by theory, it is understood that this cathode material provides a decreased polarization resistance of the cathode by increasing an ion conductivity due to the bismuth-based metal oxide as well as high electronic conductivity of the lanthanide metal oxide. Also, an electrode reaction rate may be increased by increasing a specific reaction surface area of the cathode.

Bi_{2-x-y}AₓB_{y}O₃ Formula 1

In Formula 1, A and B are metals with a valence of 3, and are each independently at least one selected from a rare earth element and a transition metal element. A and B are different from each other, and 0<x≦0.3 and 0<y≦0.3.

While not wanting to be bound by theory, it is understood that the lanthanide metal oxide acts as an electronic conductor during operation of the solid oxide fuel cell, and may include at least one compound selected from a lanthanum strontium cobalt oxide (“LSC”), a lanthanum strontium cobalt iron oxide (“LSCF”), a lanthanum strontium cobalt manganese oxide (“LSCM”), a lanthanum strontium manganese oxide (“LSM”), and a lanthanum strontium iron oxide (“LSF”).

While not wanting to be bound by theory, it is understood that the bismuth-based metal oxide acts as an ionic conductor (e.g., an oxygen ion conductor) during the operation of the solid oxide fuel cell, and the bismuth-based metal oxide has a bismuth oxide (Bi₂O₃) lattice structure with a face centered cubic structure which is co-doped with two types of elements, A and B, as shown in the Formula 1. The face centered cubic Bi₂O₃ lattice structure is understood to provide high oxygen ion conductivity because this structure basically has two vacant oxygen sites.

Also, although undoped Bi₂O₃ itself has high ionic conductivity, this is only effective at about 700° C. or more, and the ionic conductivity may be rapidly decreased by a phase transformation, which may occur at a temperature lower than about 700° C. On the other hand, the bismuth metal oxide is formed by adding co-dopants to Bi₂O₃ to provide improved stability and high ionic conductivity, even at low temperatures. The co-doped bismuth-based metal oxide has a higher ionic conductivity than a general single doped bismuth oxide. For example, it may be confirmed through the following Embodiment that the co-doped bismuth-based metal oxide provides an ionic conductivity higher than or equivalent to erbium (Er)-doped Bi₂O₃ (“ESB”), which has been regarded as having the highest ionic conductivity.

While not wanting to be bound by theory, it is understood that A and B are dopants that substitute at Bi sites in the bismuth-based metal oxide, and are metals with a valence of 3, and which are each independently at least one selected from a rare earth element and a transition metal element. In an embodiment, A and B are each independently selected from a lanthanide element and a transition metal. A and B are different metals than each other. One factor which may be considered when selecting a combination of A and B is an ionic radius. Since the ionic conductivity may be high, an average value of the ionic radii of A and B in the bismuth-based metal oxide may be about 0.1 nanometer (nm), and it may be desirable to combine an element having an ionic radius of less than about 0.1 nm with an element having an ionic radius greater than about 0.1 nm. However, embodiments are not limited thereto. In an embodiment A and B may be an element having an ionic radius of less than about 0.1 nm and an element having an ionic radius greater than about 0.1 nm. Since the high ionic conductivity may be obtained by other factors, even if the average value of the ionic radii of A and B is more than about 0.1 nm, the dopant may be selected from the rare earth element, lanthanide element, and transition element by considering factors which affect the ionic conductivity.

In an embodiment, A and B are each independently a lanthanide element. In another embodiment, for example, A and B may be selected from yttrium (Y), lanthanum (La), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and tungsten (W). An embodiment wherein A is selected from Y, Dy, and Tb, and wherein B is selected from Yb, Gd, and W is specifically mentioned. Also, when the combination of A and B is represented by (A, B), (A, B), for example, may be selected from the group consisting of (Y, Yb), (Dy, Yb), (Gd, Yb), (Tb, Yb), (Y, W), (Dy, W), (Gd, W), (Tb, W), and (Dy, Gd). For example, (A, B) may be selected from the group consisting of (Y, Yb), (Tb, W), and (Dy, Gd).

In Formula 1, the values of x and y, which are substitution amounts of A and B, are in the range of 0<x≦0.3 and 0<y≦0.3, specifically 0.05<x≦0.25 and 0.05<y≦0.25, more specifically 0.1<x≦0.2 and 0.1<y≦0.2 respectively. An embodiment wherein A is Y, B is Yb, x is about 0.1, and y is about 0.1 is specifically mentioned. A stabilizing region of the bismuth-based oxide may be lowered to room temperature by substituting A and B within the above range.

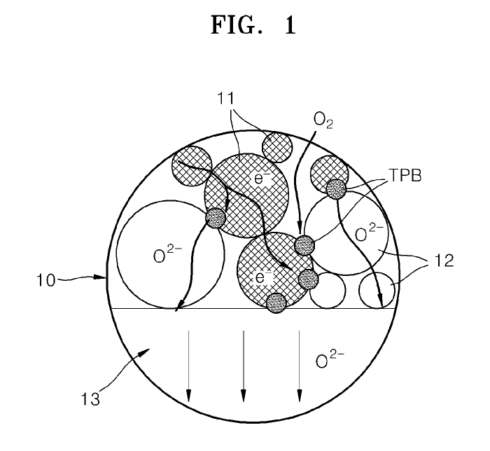

When the cathode material is used as a cathode of a solid oxide fuel cell, the cathode reaction, in which the oxygen gas is reduced to oxygen ions, is understood to occur at a triple phase boundary (“TPB”) of the lanthanide metal oxide as the electronic conductor, the bismuth-based metal oxide as the ionic conductor, and the oxygen gas. FIG. 1 is a conceptual view illustrating the triple phase boundary in the cathode.

As shown in FIG. 1, an oxygen molecule (O₂) supplied to the cathode 10 is combined with an electron transferred through a lanthanide metal oxide 11 to be reduced to an oxygen ion (O²⁻), and the oxygen ion is transferred to an electrolyte 13 (or optionally another functional layer disposed between the cathode 10 and the electrolyte) through the bismuth-based metal oxide 12. Herein, a point where the oxygen, the lanthanide metal oxide 11, and the bismuth-based metal oxide 12 contact one another, i.e., the triple phase boundary, is where a reduction reaction of the oxygen occurs. Since the specific surface area of the cathode material for a fuel cell is increased, the effective size (e.g., the concentration of TPB regions) of the triple phase boundary is increased. Therefore, the reduction reaction of the oxygen occurs more easily due to the increase in the effective size of the triple phase boundary to provide an increase in a generated amount of oxygen ions. As a result, the reaction rate of the electrode is increased, and the oxygen ion conductivity is also increased, and thus, the cathode resistance is decreased.

The bismuth-based metal oxide may be included in a range of about 70 to about 130 parts by weight, based on 100 parts by weight of the lanthanide metal oxide. For example, the bismuth-based metal oxide may be included in the range of about 80 to about 120 parts by weight, or more particularly about 90 to about 110 parts by weight, based on 100 parts by weight of the lanthanide metal oxide. When the bismuth-based metal oxide is included in the foregoing range, the specific surface area of the cathode material for a fuel cell may also be increased.

In another aspect, a cathode for a fuel cell including the foregoing cathode material for a fuel cell is provided. Particularly, the cathode may be usefully applied as a cathode of a solid oxide fuel cell.

In another aspect, a method of manufacturing the cathode for a fuel cell is provided. The method of the manufacturing of the cathode for a fuel cell includes: preparing a solution including the foregoing cathode material for a fuel cell; coating the solution on a substrate; and heat treating the coating to manufacture the cathode.

For example, to provide the foregoing cathode material for a fuel cell, the lanthanide metal oxide and the bismuth-based metal oxide may be combined (e.g., mixed) with a solvent to prepare a slurry, and the cathode for a fuel cell may be manufactured by coating the solution on a substrate and heat treating the coating.

The substrate on which the solution is coated may be an electrolyte or an electrolyte including a functional layer on at least at one surface thereof. For example, the substrate may be a solid oxide electrolyte or a solid oxide electrolyte including a functional layer at least at one surface thereof. The functional layer may substantially prevent or effectively suppress an occurrence of a nonconductive layer between the electrolyte and the electrode by substantially preventing or effectively suppressing a reaction therebetween, and may be formed on at least at one surface of the electrolyte.

The solution may be coated on the electrolyte or on the functional layer disposed on the electrolyte using various coating methods such as dip coating, roll coating, comma coating, or spray coating.

In the heat treating of the solution thus coated, the heat treatment may be performed at a temperature of about 600° C. to about 800° C. For example, the heat treatment may be performed at a temperature of about 700° C. to about 800° C., or about 750° C. By heat treating in the above temperature range, a cathode may be manufactured having a reduced polarization without a loss to the desirable electrical properties and microstructures of the lanthanide metal oxide and the bismuth-based metal oxide included in the cathode material. When considering an operating temperature of a low or medium-temperature SOFC of 800° C. or less, the cathode manufactured at the above heat treatment temperature may stably act as a mixed conductor without loss to the desirable electrical properties of the lanthanide metal oxide and the bismuth-based metal oxide after the SOFC operation.

A second cathode layer, which may include a commercially available cathode material, may be additionally formed on the cathode for a fuel cell thus manufactured.

In another aspect, a solid oxide fuel cell is provided. According to an exemplary embodiment, the solid oxide fuel cell includes: a first cathode including the foregoing cathode material for a fuel cell; an anode disposed opposite (e.g., to face or facing) the first cathode; and a solid oxide electrolyte disposed between the first cathode and the anode.

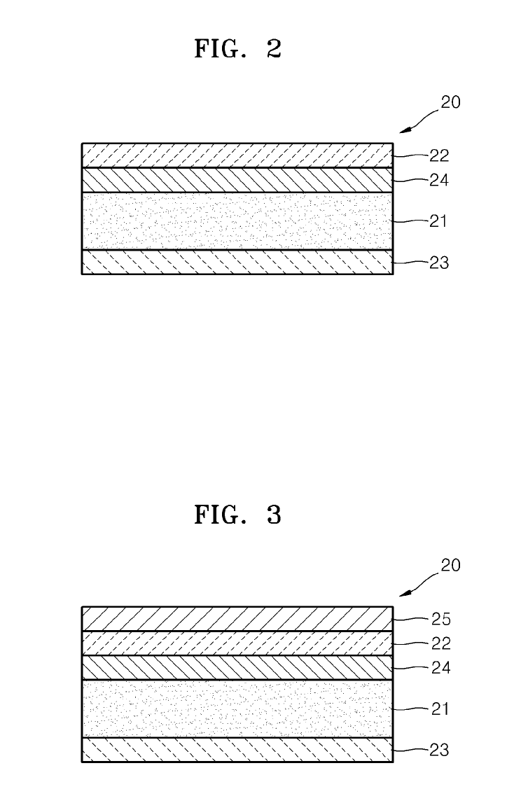

FIG. 2 is a cross-sectional view schematically illustrating a structure of a solid oxide fuel cell according to an exemplary embodiment.

Referring to FIG. 2, a solid oxide fuel cell 20 has a first cathode 22 and an anode 23 which are disposed at opposite sides of a solid oxide electrolyte 21.

The solid oxide electrolyte 21 may be sufficiently dense to substantially or effectively prevent the mixing of air and fuel, and may have high oxygen ion conductivity and low electronic conductivity. Also, since the first cathode 22 and the anode 23, which have a very large difference in oxygen partial pressures, are positioned at opposite sides of the electrolyte 21, the above physical properties may be maintained in a wide oxygen partial pressure region.

A material constituting the solid oxide electrolyte 21 is not particularly limited and it may be a solid electrolyte material generally used in the art. For example, stabilized zirconia-based materials such as yttria-stabilized zirconia (“YSZ”), scandia-stabilized zirconia (“ScSZ”) or the like; ceria-based materials in combination with a rare earth element such as samaria-doped ceria (“SDC”), gadolina-doped ceria (“GDC”) or the like; and others such as ((La, Sr)(Ga, Mg)O₃) (“LSGM”) based materials or the like may be used as the solid oxide electrolyte 21.

Thickness of the solid oxide electrolyte 21 may be in the range of about 10 nm to about 100 micrometers (μm). For example, the thickness of the solid oxide electrolyte 21 may be in the range of about 100 nm to about 50 μm, specifically about 1 μm to about 25 μm.

The anode (fuel electrode) 23 provides for electrochemical oxidation of the fuel and electric charge transfer. Therefore, certain physical properties of a fuel oxidation catalyst can be desirable to provide a suitable anode catalyst. Further, it is desirable to use the anode catalyst which is chemically stable in the presence of the electrolyte material and also has a coefficient of thermal expansion which is similar to a coefficient of thermal expansion of the electrolyte material. The anode 23 may include a cermet in which a material forming the solid oxide electrolyte 21 and a nickel oxide or the like are combined (e.g., mixed). For example, when YSZ is used as an electrolyte, a Ni/YSZ composite (e.g., a ceramic-metallic composite) may be used. In addition, a Ru/YSZ cermet or a pure metal such as Ni, Co, Ru, Pt, or the like may be used as an anode 23 material, but the material is not limited thereto. The anode 23 may additionally include an active carbon if desired. The anode 23 may have an appropriate porosity so that the fuel gas can sufficiently diffuse into the anode 23.

A thickness of the anode 23 may be in the range of about 1 μm to about 1000 μm. For example, the thickness of the anode 23 may be in the range of about 5 μm to about 100 μm, specifically about 10 μm to about 90 μm.

At the first cathode (e.g., air electrode) 22, an oxygen gas is reduced to oxygen ions, and a constant oxygen partial pressure is maintained by continuously flowing air to the first cathode 22. As further disclosed above, the first cathode 22 includes the cathode material for a fuel cell including the lanthanide metal oxide having a perovskite-type crystal structure and the doubly doped bismuth-based metal oxide. Since the cathode material for a fuel cell is the same as that disclosed above, further detailed description thereof will not be provided again.

A thickness of the first cathode 22 may be in the range of about 1 μm to about 100 μm. For example, the thickness of the first cathode 22 may be in the range of about 5 μm to about 50 μm, specifically about 10 μm to about 40 μm.

The first cathode 22 may have an appropriate porosity in order that the oxygen gas can sufficiently diffuse into the first cathode 22.

According to an exemplary embodiment, a functional layer 24 may be further included between the first cathode 22 and the solid oxide electrolyte 21. The functional layer 24 may substantially prevent or effectively suppresses an occurrence of a nonconductive layer between the first electrode 22 and the electrolyte 21 by substantially preventing or effectively suppressing a reaction therebetween. The functional layer 24, for example, may include at least one selected from a gadolinium-doped ceria (“GDC”), a samarium-doped ceria (“SDC”), and a yttrium-doped ceria (“YDC”). A thickness of the functional layer 24 may be in the range of about 1 μm to about 50 μm. For example, the thickness of the functional layer 24 may be in the range of about 2 μm to about 30 μm, specifically about 2 μm to about 10.

According to an exemplary embodiment, the solid oxide fuel cell 20 may further include a second cathode 25 including an electronic conductor on at least one surface of the first cathode 22. For example, as shown in FIG. 3, the second cathode 25 may be disposed at an outer surface of the first cathode 22. The second cathode 25 may include the electronic conductor, and may act as a current collector which collects electricity in a cathode configuration.

The second cathode 25, for example, may include at least one selected from a lanthanum cobalt oxide (e.g., LaCoO₃), a lanthanum strontium cobalt oxide (“LSC”), a lanthanum strontium cobalt iron oxide (“LSCF”), a lanthanum strontium cobalt manganese oxide (“LSCM”), a lanthanum strontium manganese oxide (“LSM”), and a lanthanum strontium iron oxide (“LSF”). The second cathode 25 may be formed using the above listed materials alone, or by combining at least one or two or more of them. Also, it is possible for the second cathode 25 to have a single layer or to have a stacked structure comprising two or more layers, wherein each layer may independently comprise at least one of these materials.

Since the solid oxide fuel cell may be manufactured using a commercially available method or a method known in the art through various publications, the details of which can be determined without undue experimentation, further detailed description of such methods will not be provided. Also, the solid oxide fuel cell may be configured to have various structures such as a tubular stack, a flat tubular stack, or a planar type stack.

Hereinafter, while the present disclosure is exemplified using the following examples, the scope of the present disclosure shall not be limited to the following examples.

### Manufacturing Example 1

### Manufacture of (LSCF+Bi_{1.8}Y_{0.1}Yb_{0.1}O₃) Cathode Material

A slurry was made by mixing about 13.967 grams (g) of Bi₂O₃, about 0.376 g of Y₂O₃, and about 0.656 g of Yb₂O₃ in about 40 milliliters (ml) of ethanol. After drying the slurry at about 70° C., the powder thus obtained was ground using a mortar, and Bi_{1.8}Y_{0.1}Yb_{0.1}O₃ was manufactured by heat treating the powder at about 800° C. for about 2 hours.

A cathode material for a fuel cell was manufactured by mixing La_{0.6}Sr_{0.4}CO_{0.2}Fe_{0.8}O_{3-ε} (LSCF″) (FCM, USA) (where, ε is a value that makes the lanthanide metal oxide expressed with the above chemical formula electrically neutral) and Bi_{1.8}Y_{0.1}Yb_{0.1}O₃ in the weight ratio of 1:1.

### Manufacturing Example 2

### Manufacture of (LSCF+Bi_{1.85}Dy_{0.1}Gd_{0.05}O₃) Cathode Material

Except for the manufacturing of Bi_{1.85}Dy_{0.1}Gd_{0.05}O₃ as an ionic conductor using about 14.094 g of Bi₂O₃, about 0.609 g of Dy₂O₃, and about 0.296 g of Gd₂O₃, a cathode material for a fuel cell was manufactured using the same process as Manufacturing Example 1.

### Manufacturing Example 3

### Manufacture of (LSCF+Bi_{1.85}Tb_{0.1}W_{0.05}O₃) Cathode Material

Except for the manufacturing of Bi_{1.85}Tb_{0.1}W_{0.05}O₃ as an ionic conductor using about 14.064 g of Bi₂O₃, about 0.586 g of Tb₂O₃, and about 0.338 g of W₂O₃, a cathode material for a fuel cell was manufactured using the same process as Manufacturing Example 1.

### Comparative Examples 1-2

For comparison with the ionic conductivity values of the ionic conductors used in the cathode materials of Manufacturing Examples 1-3, an Er-doped bismuth oxide (Bi₂O₃) (“ESB”), according to that reported in “D. W. Jung et. al., 208^{th} ECS meeting (2005), Los Angeles, Abstract 1049,” the contents of which are herein incorporated by reference in their entirety, was used for Comparative Example 1, and a gadolinium-doped ceria (“GDC”) (Ce_{0.9}Gd_{0.1}O₂) (FCM, USA) was used for Comparative Example 2.

### Evaluation Example 1

### Ionic Conductivity Measurements of Ionic Conductors

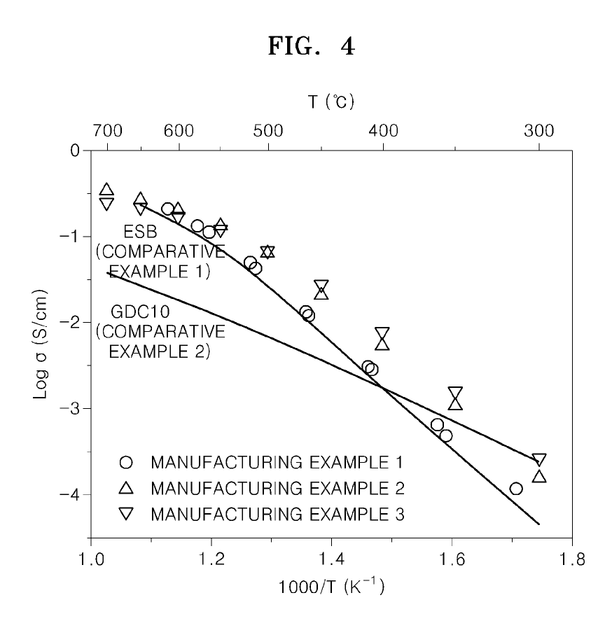

Ionic conductivities of the ionic conductors used in the cathode materials of Manufacturing Examples 1-3, i.e., Bi_{1.8}Y_{0.1}Yb_{0.1}O₃, Bi_{1.85}Dy_{0.1}Gd_{0.05}O₃, and Bi_{1.85}Tb_{0.1}W_{00.5}O₃, and ionic conductivities of the ionic conductors of Comparative Examples 1-2 were measured in air using a Keithley 2400 source meter, and the result is presented in FIG. 4.

As shown in FIG. 4, the ionic conductors used in the cathode materials of Manufacturing Examples 1-3 have ionic conductivities higher than or similar to a single doped Er-doped Bi₂O₃ (ESB, Comparative Example 1) which is known to have the highest ionic conductivity among commercially available bismuth oxides. Also, it may be understood that the ionic conductors used in the cathode materials of Manufacturing Examples 1-3 have ionic conductivities higher than GDC (Comparative Example 2) which shows a high ionic conductivity as a low or medium-temperature solid oxide fuel cell material. From the above results, it is considered that the ionic conductors of Manufacturing Examples 1-3 may decrease cathode polarization resistance when utilized as a mixed conductor layer through mixing with the LSCF cathode material.

### Comparative Example 3

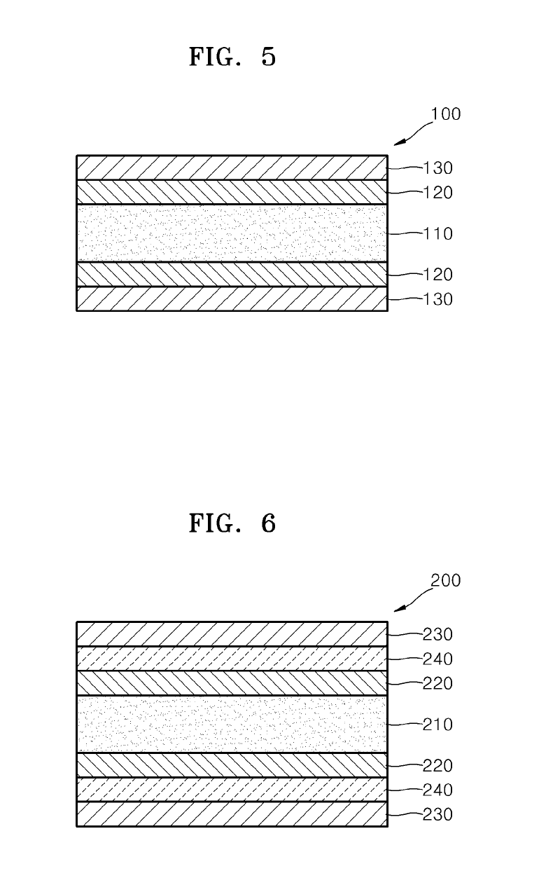

In order to measure the cathode resistance, a symmetrical unit cell 100 was manufactured by sequentially coating a pair of functional layers 120 and a pair of cathode layers 130 at both sides of an electrolyte layer 110 positioned in the center like in the structure of FIG. 5, and the symmetrical unit cell 100 was used as a control group.

In the manufacturing of the unit cell 100, the electrolyte layer 110 was manufactured using scandia-stabilized zirconia (“ScSZ”) powder (Zr_{0.8}Sr_{0.2}O_{2-ζ}, where, ζ is a value that makes the zirconium-based metal oxide expressed with the above chemical formula electrically neutral) (FCM, USA). After pressing the powder that was put in a metal mold, an electrolyte material having a thickness of about 1 millimeter (mm) and a coin shape was manufactured by sintering a pressed pellet at about 1550° C. for about 8 hours, and then, this was formed as the electrolyte layer 110. In addition, a gadolinium-doped ceria (“GDC”) (Ce_{0.9}Gd_{0.1}O_{2-η}, where, η, is a value that makes the ceria-based metal oxide expressed with the above chemical formula electrically neutral) (FCM, USA) was made to a slurry using ethanol as a solvent. The slurry was screen printed on both faces of the electrolyte layer 110, and the functional layers 120 having a thickness of about 10 μm were formed by heat treating at about 1200° C. for about 2 hours. Subsequently, La_{0.6}Sr_{0.4}CO_{0.2}Fe_{0.8}O_{3-ε} (where, ε is a value that makes the lanthanide metal oxide expressed with the above chemical formula electrically neutral) (FCM, USA) was made in to a slurry using ethanol as a solvent. The slurry was screen printed on the functional layers 120, and the cathode layers 130 having a thickness of about 30 μm were formed by heat treating at about 700° C. for about 2 hours such that the unit cell 100 was completed.

### Embodiment 1

In order to measure the cathode resistance, a unit cell 200 was manufactured by sequentially coating a pair of functional layers 220, a pair of first cathode layers 240, and a pair of second cathode layers 230 at both sides of an electrolyte layer 210 centrally positioned like the structure of FIG. 6.

Herein, the electrolyte 210, the functional layers 220, and the second cathode layers 230 are formed by the same process as the electrolyte 110, the functional layers 120, and the cathode layers 130 of Comparative Example 3.

Also, after forming the functional layers 220, about 1 g of the cathode material manufactured in Manufacturing Example 1 was made to a slurry using about 1 ml of ethanol. The slurry was screen printed on the functional layers 220, and the first cathode layers 240 having a thickness of about 20 μm was formed by heat treating at about 700° C. for about 2 hours.

### Embodiment 2

Except for the forming of the first cathode layers 240 and the second cathode layers 230 by setting heat treatment temperatures at about 800° C. during the forming of the first cathode layers 240 and the forming of the second cathode layers 230, respectively, a unit cell 200 was manufactured by performing the same process as in Embodiment 1.

### Embodiment 3

Except for the forming of the first cathode layers 240 and the second cathode layers 230 by setting heat treatment temperatures at about 900° C. during the forming of the first cathode layers 240 and the forming of the second cathode layers 230, respectively, a unit cell 200 was manufactured by performing the same process as in Embodiment 1.

### Embodiment 4

Except for the forming of the first cathode layers 240 and the second cathode layers 230 by setting heat treatment temperatures at about 1000° C. during the forming of the first cathode layers 240 and the forming of the second cathode layers 230, respectively, a unit cell 200 was manufactured by performing the same process as in Embodiment 1.

### Embodiment 5

Except for the use of the cathode material manufactured in Manufacturing Example 2 when forming the first cathode layers 240, a unit cell 200 was manufactured by performing the same process as in Embodiment 1.

### Embodiment 6

Except for the use of the cathode material manufactured in Manufacturing Example 3 when forming the first cathode layers 240, a unit cell 200 was manufactured by performing the same process as in Embodiment 1.

### Evaluation Example 2

### Impedance Measurement of Comparative Example 3

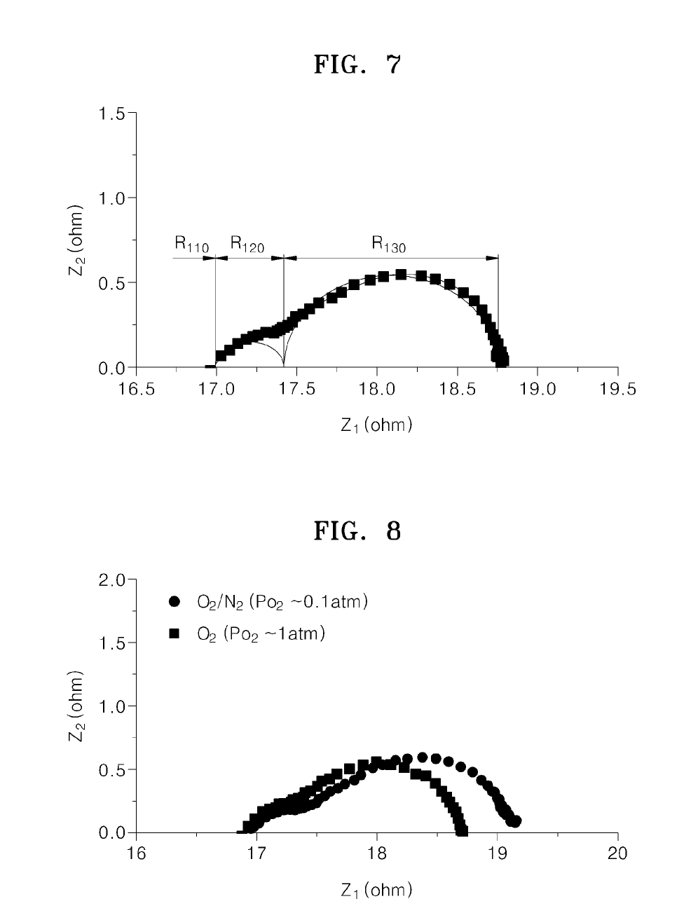

An impedance of the unit cell 100 manufactured in the Comparative Example 3 was measured in an air condition, and the result was presented in FIG. 7. A Materials Mates 7260 of Materials Mates was used as an impedance meter. Also, an operating temperature of the unit cell 100 was maintained at about 600° C.

In FIG. 7, Z₁ is a resistance, Z₂ is a reactance. R₁₁₀ denotes a resistance of the electrolyte layer 110 because a reactance value corresponding thereto is zero (0). Also, as can be seen in the following Evaluation Example 2-(a), R₁₂₀ denotes a resistance of the functional layer 120, and R₁₃₀ denotes a resistance of the cathode layer 130. R₁₂₀ and R₁₃₀ were obtained by curve fitting the impedance data of FIG. 7 as a solid line illustrated in FIG. 7.

### Evaluation Example 2-(a)

### Impedance Measurement Depending on Oxygen Partial Pressures of Comparative Example 3

In order to identify which layers among the unit cell 100 have resistances R₁₂₀ and R₁₃₀, the impedance of the unit cell 100 was measured by changing the oxygen partial pressure, and the result is presented in FIG. 8. The impedance meter and the operating temperature of the test cell 100 were the same as in Evaluation Example 2.

Referring to FIG. 8, the resistance, which corresponds to R₁₂₀ of FIG. 7 among the resistances of FIG. 8, was almost unchanged when the oxygen partial pressure was changed (PO₂: 0.1→1 atmosphere (atm)), and the resistance corresponding to R₁₃₀ of FIG. 7 was decreased when the oxygen partial pressure was increased (PO₂: 0.1→1 atm). From these results, it may be understood that the resistance corresponding to R₁₂₀ of FIG. 7 is a resistance of the functional layer 120 that does not directly contact air, and the resistance corresponding to R₁₃₀ of FIG. 7 is a resistance of the cathode layer 130 that directly contacts air. Also, total resistance (Rₜ) of the unit cell 100 is a sum of the resistance of the functional layer 120 and the resistance of the cathode layer 130. Since the resistance of the cathode layer 130 is much larger than that of the functional layer 120, it may be understood that there is a need to reduce the resistance of the cathode layer 130 in order to reduce the total resistance (Rₜ) of the unit cell 100.

### Evaluation Example 2-(b)

### Resistance Measurement Depending on Oxygen Partial Pressures of Comparative Example 3

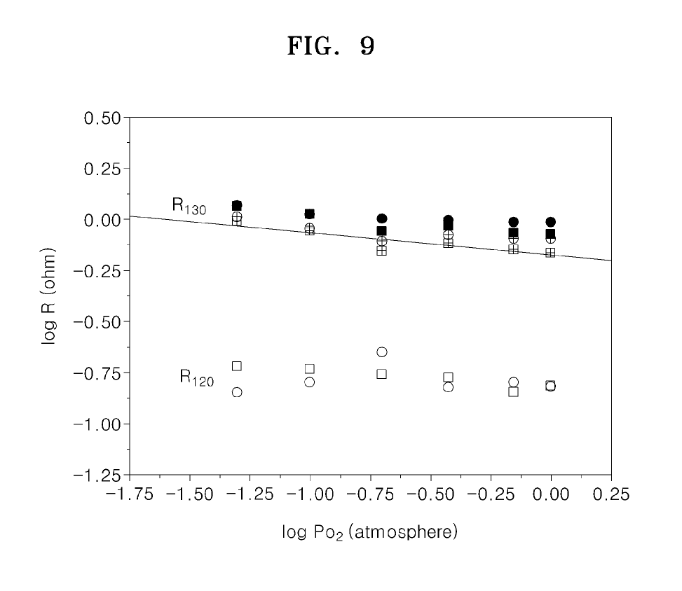

While variously changing the oxygen partial pressure, an impedance measurement test like that in Evaluation Example 2-(a) was repeated for the unit cell 100. Subsequently, the resistance (R₁₂₀) of the functional layer 120 and the resistance (R₁₃₀) of the cathode layer 130, which are obtained by curve fitting the impedance data, are presented according to oxygen pressure in FIG. 9. At this time, a reproducibility test was performed together in the same conditions.

Referring to FIG. 9, R₁₂₀ is independent of partial oxygen pressure and R₁₃₀ is dependent on partial oxygen pressure. The foregoing result agrees with the result of Evaluation Example 3. Also, a straight line is obtained when curve fitting the R₁₃₀ data in FIG. 9, and it may be understood that the R₁₂₀ has a constant correlation with the oxygen partial pressure from this result. Also, as a result of repeated tests, a trend emerged showing the results are reproducible.

### Evaluation Example 3

### Impedance Measurements of Embodiments 1-4

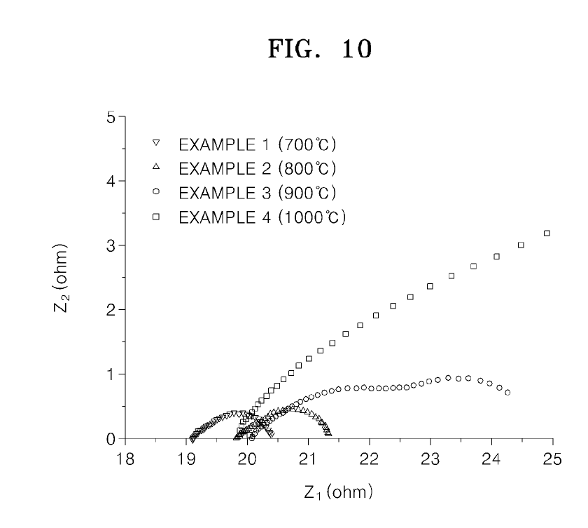

Impedances of the unit cells 200 manufactured in Embodiments 1-4 were measured in an air atmosphere, and the result is presented in FIG. 10. The impedance meter and the operating temperature of the unit cell 200 were the same as Evaluation Example 2.

Referring to FIG. 10, it may be understood that the unit cells 200 manufactured in Embodiments 1-4 have lower cathode resistances as the heat treatment temperature of the first cathode layers 240 becomes lower. Although there was not much difference in the cathode resistance when heat treating at about 700° C. and about 800° C., a considerable resistance change was generated when heat treating at about 900° C. and about 1000° C. It was considered that this is due to a reaction between LSCF and Bi_{1.8}Y_{0.1}Yb_{0.1}O₃ in the first cathode layers 230, and this may be also confirmed by the result of X-ray diffraction (“XRD”) measurements of the following Evaluation Example 3-(a).

When comparing the impedance measurement result of Embodiments 1-2 shown in FIG. 10 with the impedance measurement result of Comparative Example 3 shown in FIG. 7, it may be understood that the total resistances of the unit cells 200 manufactured in Embodiments 1-2 are smaller than that of the unit cell 100 manufactured in the Comparative Example 3. Since the unit cells 200 manufactured in Embodiments 1-2 include the first cathode layers 240 having a large triple phase boundary, oxygen ionic conductivity is increased by generating a fast reaction (i.e., a reduction reaction of oxygen) as compared to the unit cell 100 manufactured in Comparative Example 3. As a result, the foregoing result was due to the fact that the total cathode resistance (i.e., the sum of resistances of the first cathode layers 240 and the second cathode layers 230) was decreased.

### Evaluation Example 3-(a)

### XRD Pattern Measurements of Embodiments 1-4

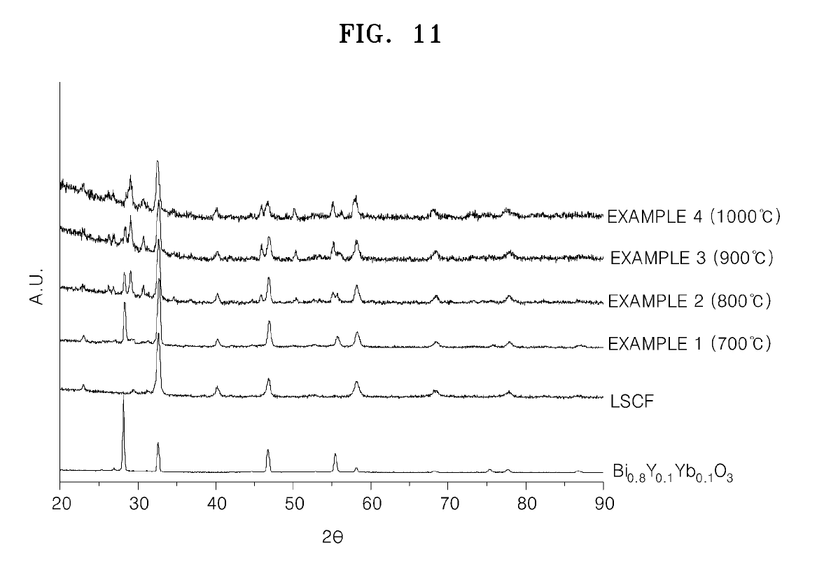

In order to examine reactivities of the LSCF and the bismuth-based oxide according to heat treatment temperature, X-ray diffraction patterns were measured using the CuKα line on the first oxide layers 240 of the unit cells 200 manufactured in Embodiments 1-4, and the result is presented in FIG. 11.

As shown in FIG. 11, it may be understood that a second reaction phase is generated during heat treating at a temperature of about 800° C. or more, and the second phase is remarkably increased as the heat treatment temperature becomes higher. This suggests that electrical properties and microstructures of LSCF and Bi_{1.8}Y_{0.1}Yb_{0.1}O₃ materials may be changed during heat treating of the first cathode layers 240 at about 800° C. or more. This may directly be accompanied with changes in the cathode polarization resistance, and it may be understood that large resistances are presented during heat treating at about 900° C. or more as shown in FIG. 10.

### Evaluation Example 4

### Cathode Resistance Measurements of Comparative Example 3 and Embodiment 1

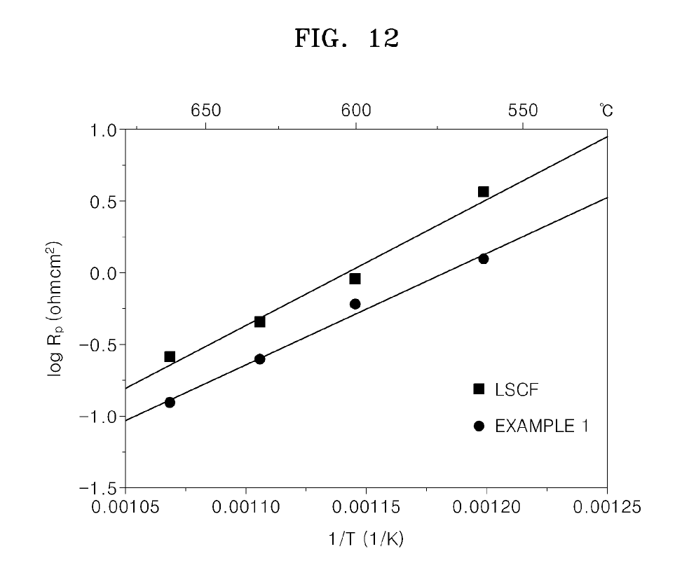

While variously changing the operating temperatures of the unit cells 100 and 200 manufactured in Comparative Example 3 and Embodiment 1, an impedance of the each unit cell was measured in an air atmosphere. The impedance meter was the same as in Evaluation Example 1. Total resistances (Rₜ) of the unit cells 100 and 200 depending on the operating temperature were obtained by curve fitting of the impedance data, and the result is presented in FIG. 12.

Referring to FIG. 12, the total resistance (Rₜ) of the unit cell 200 manufactured in Embodiment 1 is smaller than that of the unit cell 100 manufactured in Comparative Example 3 regardless of the operating temperature. Also, the total resistance (Rₜ) increases as the operating temperature decreases.

As described above, according to the one or more of the above embodiments of the present invention, the cathode material for a fuel cell decreases the cathode polarization resistance of a solid oxide fuel cell such that performance degradation of an electrode may be prevented by maintaining a low electrode resistance even at a low temperature of about 800° C. or less.

While the present disclosure has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A cathode material for a fuel cell, the cathode material comprising:
a lanthanide metal oxide having a perovskite crystal structure; and
a bismuth metal oxide represented by Formula 1 below,
Bi_{2-x-y}AₓB_{y}O₃, Formula 1
wherein
A and B are each a metal with a valence of 3,
A and B are each independently at least one element selected from a rare earth element and a transition metal element,
A and B are different from each other, and
0<x≦0.3 and 0<y≦0.3.

2. The cathode material for a fuel cell of claim 1, wherein A and B are each independently selected from a lanthanide element and transition metal.

3. The cathode material for a fuel cell of claim 1, wherein A and B are each independently selected from Y, La, Pr, Nd, Sm, Eu, Gd, Tb, Dy, Ho, Er, Tm, Yb, and W.

4. The cathode material for a fuel cell of claim 1, wherein, when a combination of A and B is represented by (A, B), (A, B) is selected from (Y, Yb), (Dy, Yb), (Gd, Yb), (Tb, Yb), (Y, W), (Dy, W), (Gd, W), (Tb, W), and (Dy, Gd).

5. The cathode material for a fuel cell of claim 4, wherein (A, B) is selected from (Y, Yb), (Tb, W), and (Dy, Gd).

6. The cathode material for a fuel cell of claim 1, wherein the lanthanide metal oxide comprises at least one selected from a lanthanum strontium cobalt oxide, a lanthanum strontium cobalt iron oxide, a lanthanum strontium cobalt manganese oxide, a lanthanum strontium manganese oxide, and a lanthanum strontium iron oxide.

7. The cathode material for a fuel cell of claim 1, wherein the bismuth metal oxide is included in a range of about 70 to about 130 parts by weight, based on 100 parts by weight of the lanthanide metal oxide.

8. A cathode for a fuel cell comprising the cathode material for a fuel cell according to claim 1.

9. A method of manufacturing a cathode for a fuel cell, the method comprising:
preparing a solution comprising the cathode material for a fuel cell according to claim 1;
coating the solution on a substrate; and
heat treating the coating to manufacture the cathode.

10. The method of claim 9, wherein the heat treating is performed at a temperature of about 600° C. to about 800° C.

11. The method of claim 9, wherein the substrate is an electrolyte or an electrolyte comprising a functional layer on at least one surface thereof.

12. A solid oxide fuel cell comprising:
a first cathode comprising the cathode material for a fuel cell according to claim 1;
an anode disposed opposite the first cathode; and
a solid oxide electrolyte disposed between the first cathode and the anode.

13. The solid oxide fuel cell of claim 12, further comprising a functional layer between the first cathode and the solid oxide electrolyte, to prevent or suppress a reaction therebetween.

14. The solid oxide fuel cell of claim 13, wherein the functional layer comprises at least one selected from a gadolinium-doped ceria, a samarium-doped ceria, and a yttrium-doped ceria.

15. The solid oxide fuel cell of claim 12, further comprising a second cathode including an electronic conductor on at least one surface of the first cathode.

16. The solid oxide fuel cell of claim 15, wherein the second cathode is disposed at an outer side of the first cathode.

17. The solid oxide fuel cell of claim 15, wherein the second cathode comprises at least one selected from a lanthanum cobalt oxide, a lanthanum strontium cobalt oxide, a lanthanum strontium cobalt iron oxide, a lanthanum strontium cobalt manganese oxide, a lanthanum strontium manganese oxide, and a lanthanum strontium iron oxide.
